(19) United States
(12) Patent Application Publication
(10) Pub. No.: US 2026/0287257 A1
(43) Pub. Date: Sep. 24, 2026

(54) KILNS WITH PYROMETRIC CONE-ACTIVATED CONTROL SWITCHES

(71) Applicant: James G. BAILEY, Kingston, NY (US)

(72) Inventor: James G. BAILEY, Kingston, NY (US)

(21) Appl. No.: 19/572,569

(22) Filed: Mar. 19, 2026

Related U.S. Application Data
(60) Provisional application No. 63/776,956, filed on Mar. 24, 2025.

(51) Int. Cl. F27B 5/18; F27D 19/00

(52) U.S. Cl. CPC F27B 5/18; F27D 19/00; F27D 2019/0018

(57) ABSTRACT

Kilns with pyrometric member-activated control switches that cut off heating of the kiln, and related methods. The kilns include a switching device comprising a first electrical contact and a pivoting assembly comprising a rotatable rotation member, an sensing rod extending from the rotation member to an interior potion of a switch opening in a wall of the kiln, and an exterior contact rod extending from the rotation member with a second electrical contact positioned below the first electrical contact. The pivoting assembly is initially in a first orientation with the sensing rod being supported by a cantilevered pyrometric member and the first electrical contact spaced from the second electrical contact portion. Upon deformation of the pyrometric member, the pivoting assembly rotates to a second orientation with the first and second electrical contact in electrical connection.

### CROSS-REFERENCE TO RELATED APPLICATION

This application perfects and claim priority benefit of U.S. Provisional Patent Application No. 63/776,956, filed on March, 24, 2025, entitled Kilns With Pyrometric Cone-Activated Control Switches, which is hereby expressly incorporated herein in its entirety.

### TECHNICAL FIELD

This application relates generally to kilns with pyrometric cone-activated electronic control switches. More particularly, the application relates to gas powered kilns with pyrometric cone-activated electronic control switches that cut-off heating during a pottery, ceramic and/or glasswork firing process of the kiln when a pyrometric cone within the kiln experiences a predetermined amount of heat work.

### BACKGROUND

Kilns for firing pottery, ceramics, and metallurgy are configured to heat the wares inside of a chamber to relatively high temperatures, such as at 1,500 degrees Fahrenheit. The amount of “heat work” that the wares experience is critical to the firing process (such as on clay maturity, appearance and glaze melt, for example). Many ceramics, clays and glazes may only be properly or fully cured or formed during a firing process via a certain amount of heat work, and excess heat work will destroy, deteriorate, melt/misshapen, crack and/or otherwise distort or improperly form the ware or a portion thereof. various combinations and influences during the firing process that affect “heat work” on clay maturity, appearance and glaze melt. Indeed, the amount of heat work for certain clay, pottery, glazes and glass materials is critical, slightly less or slightly more heat work than an optimal heat work amount being the result-effective factor for success or failure in attaining a desired result.

Heat work is the combined effect of all of the conditions of inside a kiln chamber during a firing process. Various combinations and influences during the firing process affect the heat work within the chamber. Specifically, the heat work within a kiln camber is the net effect of the temperature, temperature/heating profile, time and physical and chemical environment (such as air movement/convection, pressure and chemical composition (e.g., CO2 amount)) within the kiln chamber that the wares experience during a firing process.

As temperature is only a factor in determining heat work, kilns that employ thermocouples or other means of sensing the temperature within a kiln chamber to regulate or automate the heating of the kiln do not adequately account for the other variables that effect heat work. Accordingly, many kiln operators employ pyrometric piles, cones or bars within the firing chamber to visually assess the heat work within the chamber, and the heat applied to the kiln is cut off manually. Such pyrometric members located within the kiln must be watched in the course of a firing through a transparent pane or opening in the wall of the kiln, and when a pyrometric member experiences a pre-defined amount of heat work (specified by the pyrometric member) it bends or slumps over.

A pyrometric member's design allows it extend subsidiary upright (potentially at an angle), but then bend (or “soften”) downward at a specific amount of heat work, offering a visual indicator that helps measure the heat work inside kilns or furnaces during firing. When the pyrometric member's reaches its “maturity” heat work, it bends or even melts, signaling that the intended firing heat work amount has been achieved. For example, some pyrometric members have a pyramid-like shape with a broad base that tapers to a point at the top, and is configured so that its top turns downwardly upon itself in a hairpin turn, an indication that a firing is complete because a particular amount of heat work was produced in the chamber, whereupon the heat applied to the kiln is cut off manually.

A temperature associated with a particular pyrometric member is thus an approximate temperature at which that pyrometric member deforms when heated at a specific rate and under certain chamber conditions. If the heating rate, profile or other conditions inside a particular kiln chamber differ from those specified, the pyrometric member will bend/slump at a temperature that differs from the listed/specified temperature. For example, when a manufacturer labels a glaze to fire at cone 05, it means that in order to mature, the heat work required to deform a cone 05 must be effectuated.

Pyrometric members are typically formed of a ceramic composition in the shape of a pyramid about 2 to 2.5 inches. A pyrometric cone is said to have reached an “end point” when its tip bends over and touches the surface upon which the cone is resting. A pyrometric member's composition varies according to its intended melting heat work endpoint, usually occurring in a temperature range from 1,000 to 3,000 degrees Fahrenheit (538 to 1,649 degrees Celsius), depending on the specific cone.

Attempts have been made to incorporate pyrometric members into electric switches to automatically shut off or stop the heating a kiln when a particular heat work is achieved within the kiln chamber, but such devices cannot handle the high temperatures and thick walls of modern day kilns, are extremely inaccurate and inconsistent, and are difficult to set up. For example, prior kiln cutoff switches that incorporate a pyrometric member for the triggering of the switch can only operate with thin-walled kilns of 3 inches or less, and at temperature under 1900 degrees Fahrenheit (e.g., for low fire ceramics and low fire glazes). For example, prior pyrometric-based electric kiln switches are very difficult to accurately set up the pyrometric member's location and orientation with respect to the components of the switch, and very difficult to adjust switch's components to accurately and reliable detect when the pyrometric member fully bends/slumps. As another example, drastic changes in temperature, such as the temperature difference between when the switches can be setup and today's common firing temperatures (e.g., above 2,000-3,000 degrees Fahrenheit), cause the components of the switches to warp and distort to such an extent that the accuracy and reliability of the switches are practical nonexistent. At most, such prior pyrometric-based electric kiln switches are only practically useful as last-resort backups to prevent a meltdown disaster in the kiln if the operator didn't get back to those manually fired kilns in time.

Improved pyrometric member-based electric kiln switches, and corresponding kilns and methods, that overcome one or more of the above-drawbacks are thereby needed.

While certain aspects of conventional technologies have been discussed to facilitate disclosure of Applicant's inventions, the Applicant in no way disclaims these technical aspects, and it is contemplated that their inventions may encompass one or more conventional technical aspects.

In this disclosure, where an act or item of knowledge is referred to or discussed, this reference or discussion is not an admission that the document, act or item of knowledge or any combination thereof was, at the priority date, publicly available, known to the public, part of common general knowledge, or otherwise constitutes prior art under the applicable statutory provisions; or is known to be relevant to an attempt to solve any problem with which this specification is concerned.

### SUMMARY

The present disclosure may address one or more of the problems and deficiencies of the art discussed above. However, it is contemplated that the disclosure may prove useful in addressing other problems and deficiencies in a number of technical areas. Therefore, the claimed inventions should not necessarily be construed as limited to addressing any of the particular problems or deficiencies discussed herein.

Briefly, the present disclosure satisfies the need for improved pyrometric member-based control switches for kilns, and related kilns and methods, that overcome one or more of the drawbacks of prior electronic animal containment systems. In various embodiments, the pyrometric member-based control switches for kilns are designed specifically for fuel burning larger kilns with thicker walls that used for both oxidation and reduction atmospheres. The components and configurations of the present pyrometric member-based kilns control switches are resistant to very high temperature and temperature changes, such as to resist heat-based distortion or expansion. The present pyrometric member-based kilns control switches are also very accurate and reliable, and provide for easy accurate setup and a large degree of customizations/adjustments. For example, the embodiments of the pyrometric member-based kilns control switches provide for a relatively large degree of deformation of the utilized pyrometric member, and a relatively large degree of travel of a sensing rod that interacts with the pyrometric member, so that the heat work can be accurately and reliably detected and utilized to produce a control signal.

In some embodiments, the pyrometric member-based kilns control switch assemblies and systems (and corresponding kilns) of the present disclosures include a pyrometric assembly configured to be seated on a bottom surface of a switch opening in a wall of the kiln (e.g., formed by a ceramic lentil). The pyrometric assembly may comprise a holder device configured to hold an elongate pyrometric member in an elevated position. The pyrometric assembly further includes a switching device comprising a first electrical contact and a pivoting assembly comprising a rotatable rotation member configured to rotatably couple with a kiln, an inner sensing rod configured to extend from the rotation member to an interior potion of a switch opening in a wall of the kiln, and an exterior contact rod extending from the rotation member with a second electrical contact positioned below the first electrical contact. The pivoting assembly rotates between a first orientation with the inner sensing rod being spaced a first distance from a bottom side of the switch opening and the first electrical contact spaced from the second electrical contact portion, and a second orientation with the inner sensing rod being spaced a second lesser distance from the bottom side of the switch opening and the first and second electrical contact in electrical connection. A center of gravity of the pivoting assembly is offset form the axis of rotation such that the pivoting assembly is naturally biased into the second orientation.

In one aspect, the present discloses provides a kiln comprising: a chamber defined by interior refractory walls; at least one heater configured to heat the chamber to at least 2,000 degrees Fahrenheit; a pyrometric assembly positioned on an interior portion of a switch opening extending through one of the interior walls; and a switching device configured to generate a control signal that causes the at least one heater to reduce an amount of heat that it produces. The pyrometric assembly comprises: a pyrometric holder with a bottom support side seated on a bottom side of the interior portion of the switch opening and a mounting side with a mounting aperture extending therein; and an elongate pyrometric member configured to be mounted in the mounting aperture such that in a pre-heat worked state, the pyrometric member is in a cantilever orientation with respect to the mounting side of the pyrometric holder in an elevated position above a bottom surface of the switch opening. The switching device comprises a pivoting assembly, comprising: a rotation member comprising a refractory material rotatably mounted to the kiln about an axis of rotation; an inner sensing rod comprising a refractory material extending from an inner side of the rotation member and through the switch opening to the interior portion; and an exterior contact rod extending from an outer portion of the rotation member comprising an electrically conductive first contact portion. The switching device also comprises an electrically conductive second contact portion positioned above the first contact portion. The pivoting assembly is configured to rotate about the axis of rotation between a first orientation with an inner end portion of the inner sensing rod being spaced a first distance from the bottom side of the switch opening and the first contact portion is spaced from the second contact portion, and a second orientation with the inner end portion of the inner sensing rod being positioned closer to the bottom side of the switch opening than the first distance and the first contact portion is in physical and electrical connection with the second contact portion. A center of gravity of the pivoting assembly is offset from the axis of rotation toward the interior portion of the switch opening such that the pivoting assembly is naturally biased into the second orientation.

In some embodiments, in a first configuration of the kiln: the pyrometric member is in the pre-heat worked state and mounted in the mounting aperture such that the pyrometric member is in the cantilever orientation and the elevated position; the inner portion of the inner sensing rod is positioned on the pyrometric member; and the pyrometric member maintains its elevated position and supports the pivoting assembly in the first orientation. In some such embodiments, in a second configuration of the kiln: the pyrometric member is mounted in the mounting aperture and in a post-heat worked state such that the pyrometric member is in a deformed position that extends closer to the bottom surface of the switch opening than in the elevated position; and the pivoting assembly is in the second orientation. In some such embodiments, in the pre-heat worked state, the pyrometric member is configured to maintain the elevated position, and physically support the inner portion of the inner sensing rod to maintain the first orientation of the pivoting assembly, and wherein the pyrometric member is configured to soften after being subjected to a predetermined amount of heat work to transition the pyrometric member from the pre-heat worked state to the post-heat worked state with the pyrometric member in the deformed position and the pivoting assembly biased into the second orientation. In some embodiments, in the second orientation, the inner end portion of the inner sensing rod lies on the bottom side of the switch opening.

In some embodiments, an electrical signal is applied to the second contact portion, and wherein the electrical signal is transmitted to the second contact portion when the switching device is in the second orientation to produce the control signal. In some such embodiments, the control signal shuts off a power relay that turns off the at least one heater.

In some embodiments, the control signal causes the at least one heater to stop heating the kiln chamber. In some embodiments, the exterior contact rod comprises an electrically conductive metal rod portion extending from the rotation member to the first contact portion. In some embodiments, the electrical contact portion is positioned at an end of the exterior contact rod, and wherein an electrical signal is applied to the second contact portion via exterior contact rod.

In some embodiments, the pivoting assembly further comprises a tare poise member movably coupled along a length of the exterior contact rod, the position of the tare poise along the exterior contact rod configured to alter the center of gravity of the pivoting assembly, and thereby alter the strength of a naturally-biased downward force of the inner sensing rod at the interior portion of the switch opening. In some such embodiments, the exterior contact rod and the tare poise member are threadably movably coupled.

In some embodiments, the inner ceramic sensing rod is a ceramic hollow mullite tube. In some embodiments, the switch opening extends for a length of at least 4-½ inches, and the inner ceramic sensing rod defines a length of at least 4-½ inches. In some embodiments, a top side of the mounting aperture of the pyrometric holder is positioned at least 1 inch above the bottom support side. In some embodiments, the first distance of the inner end portion of the inner sensing rod from the bottom side of the switch opening is at least ¾ inch.

In some embodiments, the elongate pyrometric member defined a length from a base portion to a tip portion of at least 2 inches. In some embodiments, the elongate pyrometric member is a pyramidal pyrometric cone.

In some embodiments, the pyrometric assembly is configured such that a top surface of the pyrometric member extends substantially horizontally when the pyrometric member is in the cantilever orientation. In some embodiments, the pyrometric holder is formed of a refractory material. In some embodiments, the pyrometric holder is removably seated on the bottom side of the interior portion of the switch opening. In some embodiments, the pyrometric assembly further comprises a malleable refractory clay positioned within the mounting aperture coupling a base portion of the pyrometric member in the mounting aperture.

In some embodiments, he switch opening is formed between refractory brick sides and top and bottom ceramic lintel supports. In some such embodiments, top and bottom ceramic lintel supports are denser, smoother and more resistant to wear by the pyrometric holder than the refractory brick sides.

In some embodiments, the interior portion of the switch opening defines a larger width than a medial portion of the switch opening. In some such embodiments, the bottom side of the interior portion of the switch opening is defined by a ceramic lintel.

In some embodiments, the thermal conductivity of the rotation member is within 10% of the thermal conductivity of the inner sensing rod at 2,000 degree Fahrenheit. In some embodiments, the thermal conductivity of the rotation member and the thermal conductivity of the inner sensing rod is less than 0.5 W/mK at mean temperature 2,000 degree Fahrenheit. In some embodiments, the coefficient of thermal expansion of the rotation member and the coefficient of thermal expansion of the inner sensing rod is less than 6×10⁻⁶/° F. from about 1500 degrees Fahrenheit to about 2500 degrees Fahrenheit.

In some embodiments, the rotation member is rotatably mounted to an exterior of the kiln and positioned over an exterior side of the switch opening. In some embodiments, the kiln further comprises at least one fiber insulation gasket extending over an exterior end of the switch opening, and wherein the inner ceramic sensing rod extends through an opening in the at least one fiber insulation gasket. In some embodiments, second contact portion comprises an adjustable height portion that is configured to vary the position of a contact surface of the second contact portion relative to the first contact portion.

In some embodiments, the switching device is configured to generate a control signal when the pivoting assembly is in the second orientation with the first and second contact portions being in electrical contact. In some such embodiments, the at least one heater comprises at least one gas burner, and wherein the control signal ultimately operates a valve which supplies a combustible gas to the at least one gas burner.

In another aspect the present disclosure provides for a method of firing a ware in a kiln, comprising mounting a the pyrometric member in the mounting aperture of the pyrometric holder in the pre-heat worked state such that the pyrometric member is in the cantilever orientation with respect to the mounting side of the holder. The method then includes positioning the pyrometric member in the interior portion of the mounting aperture such that the pyrometric member is the elevated position above the bottom surface of the switch opening and the pivoting assembly is in the first orientation with the inner sensing rod being supported by the pyrometric member. The kiln chamber may then be heated to at least 2,000 degrees Fahrenheit for a period of time to fire the ware and such that the pyrometric member experiences an amount of heat work that causes the pyrometric member to deform into the deformed position and the pivoting assembly rotates into the second orientation. The rotation of the pivoting assembly rotates into the second orientation physically and electrically couples the first and second contact portions, and thereby generates the control signal that causes the at least one heater to cutoff the heating of the kiln chamber.

It should be appreciated that all combinations of the foregoing aspects and additional concepts discussed in greater detail below (provided such concepts are not mutually inconsistent) are contemplated as being part of the inventive subject matter and to achieve the advantages disclosed herein.

These and other objects, features and advantages of this disclosure will become apparent from the following detailed description of the various aspects of the disclosure taken in conjunction with the accompanying drawings.

### BRIEF DESCRIPTION OF THE DRAWINGS

These and other features, aspects, and advantages of the present disclosure will become better understood when the following detailed description is read with reference to the accompanying drawings, which are not necessarily drawn to scale and in which like reference numerals represent like aspects throughout the drawings, wherein:

FIG. 1 illustrates, in one example, a perspective view of a kiln including pyrometric member-based control switch system, in accordance with one or more aspects of the present disclosure.

FIG. 2 illustrates, in one example, a side cross-sectional view of a portion of the kiln and the pyrometric member-based control switch system of FIG. 1, in a pre-actuated state, in accordance with one or more aspects of the present disclosure.

FIG. 3 illustrates, in one example, an interior side view of a portion of the kiln and an interior sensing rod of the pyrometric member-based control switch system of FIG. 1, in the pre-actuated state, in accordance with one or more aspects of the present disclosure.

FIG. 4 illustrates, in one example, a side cross-sectional view of a portion of the kiln and the pyrometric member-based control switch system of FIG. 1, in an actuated state, in accordance with one or more aspects of the present disclosure.

FIG. 5 illustrates, in one example, an interior side view of a portion of the kiln and an interior sensing rod of the pyrometric member-based control switch system of FIG. 1, in actuated state, in accordance with one or more aspects of the present disclosure.

FIG. 6 illustrates, in one example, a top cross-sectional view of a portion of the kiln and the pyrometric member-based control switch system of FIG. 1 in accordance with one or more aspects of the present disclosure.

FIG. 7 illustrates, in one example, an interior view of a switch opening of the kiln and an interior sensing rod of the pyrometric member-based control switch system of FIG. 1, in accordance with one or more aspects of the present disclosure.

FIG. 8 illustrates, in one example, an interior view of the switch opening of the kiln, and a pyrometric assembly and an interior sensing rod of the pyrometric member-based control switch system in the pre-actuated state, of FIG. 1, in accordance with one or more aspects of the present disclosure.

FIG. 9 illustrates, in one example, an interior view of the switch opening of the kiln, and a pyrometric assembly and an interior sensing rod of the pyrometric member-based control switch system in an actuated state, of FIG. 1, in accordance with one or more aspects of the present disclosure.

FIG. 10 illustrates, in one example, an interior perspective view of the switch opening of the kiln, and a pyrometric assembly and an interior sensing rod of the pyrometric member-based control switch system in an actuated state, of FIG. 1, in accordance with one or more aspects of the present disclosure.

FIG. 11 illustrates, in one example, another interior perspective view of the switch opening of the kiln, and a pyrometric assembly and an interior sensing rod of the pyrometric member-based control switch system in an actuated state, of FIG. 1, in accordance with one or more aspects of the present disclosure.

FIG. 12 illustrates, in one example, an interior perspective view of the switch opening of the kiln, and the pyrometric assembly being removed therefrom, of FIG. 1, in accordance with one or more aspects of the present disclosure.

FIG. 13 illustrates, in one example, an interior side view of a portion of a kiln and a pyrometric assembly of another pyrometric member-based control switch system, in a pre-actuated state, in accordance with one or more aspects of the present disclosure

FIG. 14 illustrates, in one example, a side cross-sectional view of a portion of the kiln and the pyrometric member-based control switch system of FIG. 13, in the pre-actuated state, in accordance with one or more aspects of the present disclosure.

### DETAILED DESCRIPTION

Aspects of the present disclosure and certain examples, features, advantages, and details thereof, are explained more fully below with reference to the non-limiting examples illustrated in the accompanying drawings. Descriptions of well-known materials, fabrication tools, processing techniques, etc., are omitted so as not to unnecessarily obscure the relevant details. It should be understood, however, that the detailed description and the specific examples, while indicating aspects of the disclosure, are given by way of illustration only, and are not by way of limitation. Various substitutions, modifications, additions, and/or arrangements, within the spirit and/or scope of the underlying inventive concepts will be apparent to those skilled in the art from this disclosure.

Approximating language, as used herein throughout disclosure, may be applied to modify any quantitative representation that could permissibly vary without resulting in a change in the basic function to which it is related. Accordingly, a value modified by a term or terms, such as “about” or “substantially,” is not limited to the precise value specified. For example, these terms can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%. In some instances, the approximating language may correspond to the precision of an instrument for measuring the value.

Terminology used herein is for the purpose of describing particular examples only and is not intended to be limiting. As used herein, the singular forms “a”, “an” and “the” are intended to include the plural forms as well, unless the context clearly indicates otherwise. Furthermore, references to “one example” are not intended to be interpreted as excluding the existence of additional examples that also incorporate the recited features. Moreover, unless explicitly stated to the contrary, the terms “comprising” (and any form of “comprise,” such as “comprises” and “comprising”), “have” (and any form of “have,” such as “has” and “having”), “include” (and any form of “include,” such as “includes” and “including”), and “contain” (and any form of “contain,” such as “contains” and “containing”) are used as open-ended linking verbs. As a result, any examples that “comprises,” “has,” “includes” or “contains” one or more step or element possesses such one or more step or element, but is not limited to possessing only such one or more step or element. As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable or suitable. For example, in some circumstances, an event or capacity can be expected, while in other circumstances the event or capacity cannot occur—this distinction is captured by the terms “may” and “may be.”

In various embodiments, pyrometric member-based control switches that are designed specifically for high temperature kilns with thicker walls (that use both oxidation and reduction atmospheres) is disclosed. The components and configurations of the present pyrometric member-based kilns control switches are resistant to very high temperature and temperature changes, such as to resist heat-based distortion or expansion. The present pyrometric member-based kilns control switches are also very accurate and reliable, and provide for easy accurate setup and a large degree of customizations/adjustments. For example, the embodiments of the pyrometric member-based kilns control switches provide for a relatively large degree of deformation of the utilized pyrometric member, and a relatively large degree of travel of a sensing rod that interacts with the pyrometric member, so that the heat work can be accurately and reliably detected and utilized to produce a control signal.

A kiln for firing clay, pottery, ceramic, glazes, metals and other ware at relatively high temperatures, such as at least 2,000 degrees Fahrenheit (or at least 2,500 degrees Fahrenheit, or at least 3,000 degrees Fahrenheit) is described herein and illustrated in the accompanying figures, and referenced generally by reference numeral 10. As described further below, the kiln 10 includes pyrometric member-based control switch device or system 20 that is configured to automatically generate a control signal that that causes the at least one heater 16 of the kiln 10 to reduce an amount of heat that it produces. In some embodiments, the pyrometric member-based control switch system 20 generates a control signal that shuts off a power relay that turns off the at least one heater 16.

The at least one heater 16 may be any heating device configured to heat the inner kiln chamber or cavity 12, such as to at least 2,000 degrees Fahrenheit, at least 2,500 degrees Fahrenheit, or at least 3,000 degrees Fahrenheit. For example, the at least one heater 16 may be at least one gas burner configured to combust a combustible gas via at least one gas burner. The heated combusted air/combustibles may be introduced into the chamber 12 to heat the chamber 12, for example. In some embodiments, the at least one heater 16 comprises at least one gas burner, and the pyrometric member-based control switch system 20 generates a control signal that ultimately operates a valve which supplies a combustible gas to the at least one gas burner to reduce or stop the flow of gas so as to reduce or cutoff heating of the chamber 12. However, it is noted that the pyrometric member-based control switch system 20 is equally compatible with any other heater configuration or embodiments, such as other combustion or gas heaters, or elector heaters, that are configured to heat the chamber 12. Further, the control signal generated by the pyrometric member-based control switch system 20 can be utilized any number of configurations and systems to reduce or cut off heating of the chamber 12.

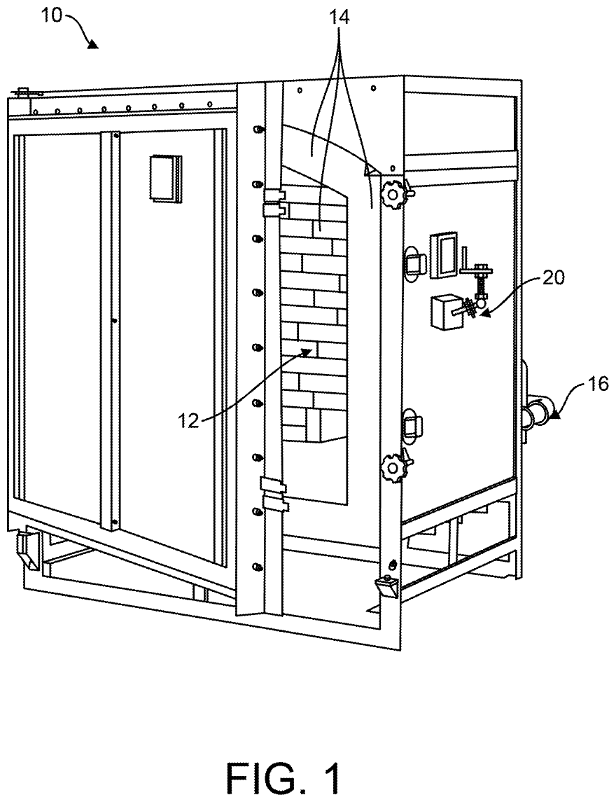

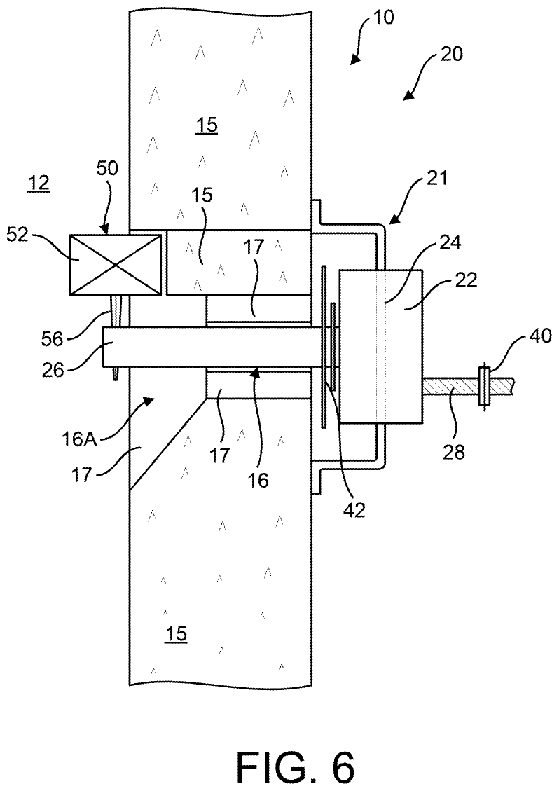

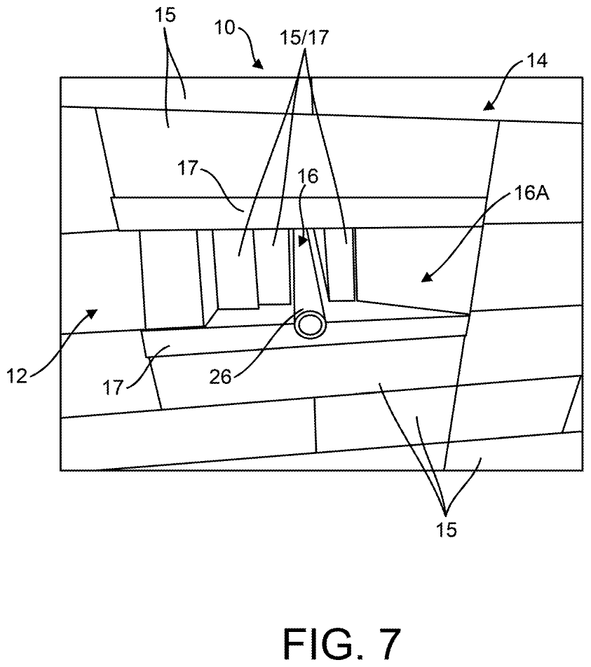

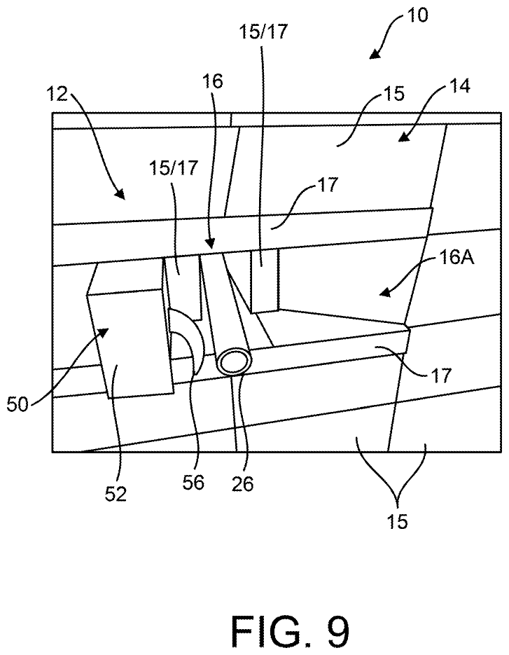

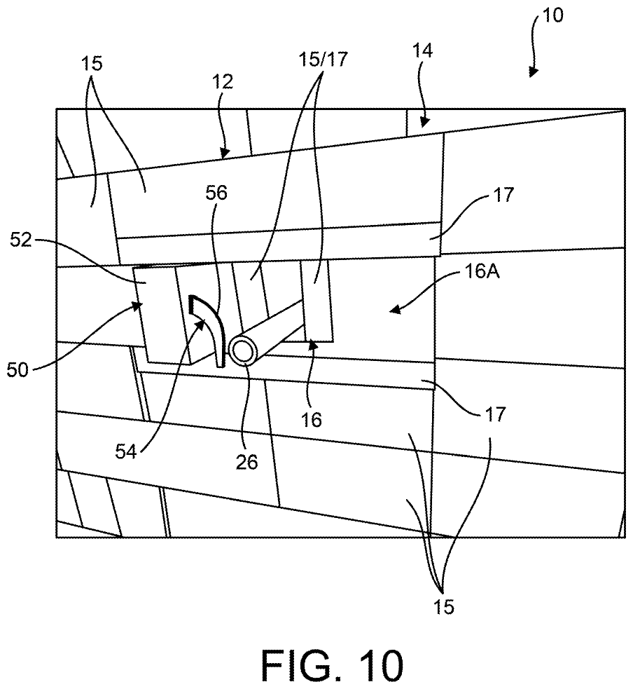

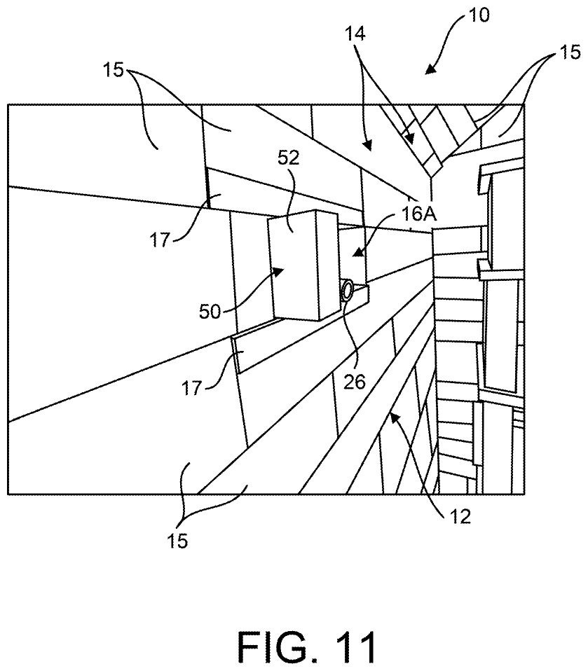

As shown in FIGS. 1-12, the chamber 12 of the kiln 12 may be defined or formed, at least in part by interior refractory walls 14. The interior refractory walls 14 may be formed of refractory (e.g., ceramic) materials, such as alumina (Al₂O₃) and/or silica (SiO₂), capable of withstanding temperatures of at least 2,000 degree Fahrenheit. The refractory walls 14 may have high refractoriness, low thermal conductivity, and high thermal shock resistance. In some embodiments, the interior refractory walls 14 may comprise refractory insulating fire bricks 15. In some embodiments, the interior refractory walls 14 may have a thermal conductivity of less than 0.5 W/mK at mean temperature 2,000 degree Fahrenheit and/or a bulk density ranging from about 0.6 to about 3.5 g/cm³, or about 0.6 to about 1.2 g/cm.

As shown in FIGS. 1-12, the kiln 10 also includes a switch opening 16 extending through one of the interior refractory walls 14. The switch opening 16 extends from the exterior of the kiln 10 to the chamber 12, and thereby entirely through the wall of the kiln 10 (including the interior refractory wall 14 and any other wall structure overlapping the interior refractory wall 14). The switch opening 16 may extend for a length of at least 4-½ inches, or at least 6 inches.

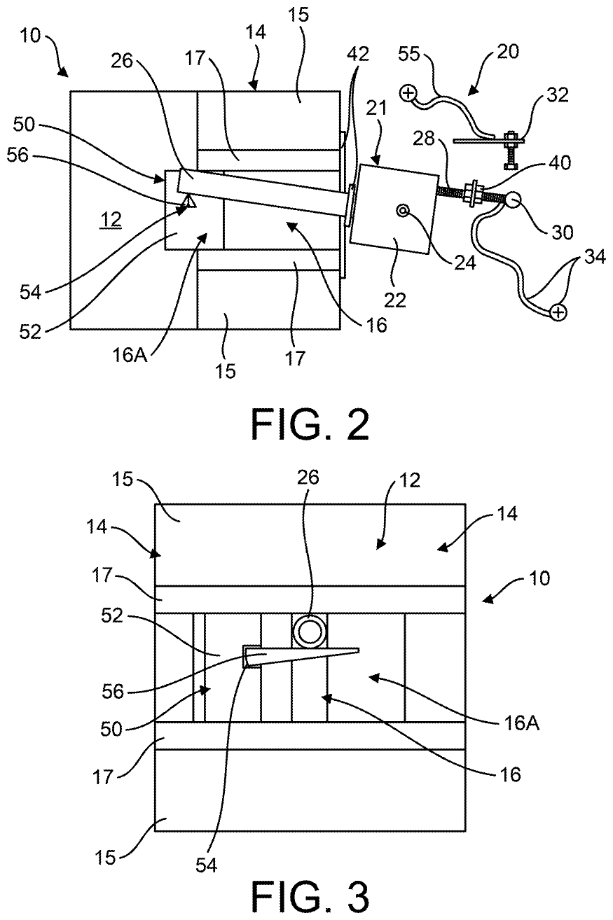

As shown, in some embodiments, the switch opening 16 may be formed by an opening in the interior refractory wall 14 such that the refractory material or bricks 15 forms side walls of the switch opening 16. Further, as shown in FIGS. 2-12, at least a portion of the top and/or bottom sides of the switch opening 16 may be formed by ceramic lintels or supports 17 that extends within or between portions of the refractory wall 14. In some other embodiments, one or more of the side walls of the switch opening 16 may also be formed by ceramic lintels or supports 17 (as opposed to the refractory material or bricks 15). In some embodiments, the ceramic lintels 17 may be formed of refractory materials, such as alumina (Al₂O₃) and/or silica (SiO₂), capable of withstanding temperatures of at least 2,000 degree Fahrenheit. In some embodiments, the ceramic lintels 17 may have a thermal conductivity of less than 0.5 W/mK at mean temperature 2,000 degree Fahrenheit and/or a bulk density ranging from about 0.6 to about 3.5 g/cm³, or about 2 to about 3.5 g/cm³. Like the refractory walls 14, the ceramic lintels 17 may have high refractoriness, low thermal conductivity, and high thermal shock resistance. The ceramic lintels 17 may differ from the refractory walls 14 in that the ceramic lintel 17 are denser, smoother and more resistant to wear by the pyrometric holder 52 (as discussed below).

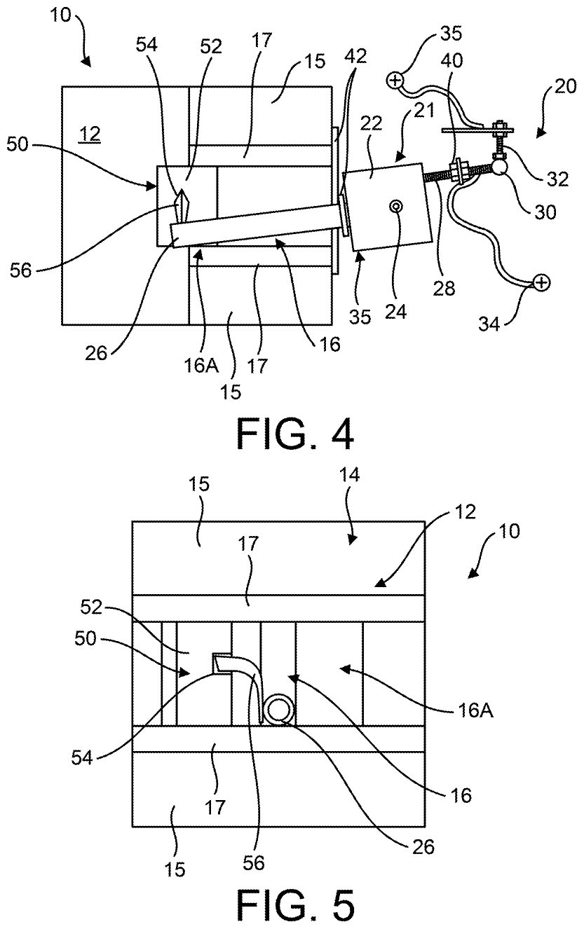

As shown in FIGS. 2-12, the kiln 10, and the pyrometric member-based control switch systems of the present disclosure, include a pyrometric assembly 50 that is configured to be removably seated or set (manually) in an interior portion 16A of the switch opening 16. The interior portion 16A is at, adjacent or partially within (or forms a part of) the kiln chamber 12, and this experiences substantially the same heat work as other areas of the kiln chamber 12. In some embodiments, as shown in FIGS. 3 and 5-12, the interior portion 16A of the switch opening 16 way taper inwardly, along a width for example, as it extends to medial and exterior portions of the switch opening 16. As shown in FIGS. 2 and 4, the width of the medial and exterior portions of the switch opening 16 may be only slightly larger (e.g., 10% larger or less) than the width of the interior sensing rod 26.

The pyrometric assembly 50 includes a free-standing pyrometric holder 52 and an elongate pyrometric member or cone 56, as shown in FIGS. 2-12. The pyrometric holder 52 includes bottom support side that is configured to be seated or lie on a bottom side of the interior portion 16A of the switch opening 16, as shown in FIGS. 3, 5 and 10. 21. The pyrometric holder 52 is thus configured to be free or removably seated on the bottom side of the interior portion 16A of the switch opening 16.

The pyrometric holder 52 may be formed of refractory (e.g., ceramic) materials, such as alumina (Al₂O₃) and/or silica (SiO₂), capable of withstanding temperatures of at least 2,000 degree Fahrenheit. The pyrometric holder 52 may have high refractoriness, low thermal conductivity, and high thermal shock resistance. In some embodiments, the pyrometric holder 52 may have a thermal conductivity of less than 0.5 W/mK at mean temperature 2,000 degree Fahrenheit, and/or a coefficient of thermal expansion of less than about 6×10⁻⁶/° F. from about 1,500 degrees Fahrenheit to about 2,500 degrees Fahrenheit, and/or a bulk density ranging from about 0.6 to about 3.5 g/cm³, or about 0.6 to about 1.2 g/cm³, or about 2 to about 3.5 g/cm³. In some embodiments, the pyrometric holder 52 may be formed of the same or similar materials as insulating fire bricks (IFBs), refractory fire bricks or the like.

As also shown in FIGS. 3 and 5-12, the pyrometric holder 52 includes a mounting side with a mounting aperture or recess 54 extending therein. A top side of the mounting aperture 54 of may be positioned at least 1 inch, or at least 2 inches, above the bottom support side. In some embodiments, the top side of the mounting aperture 54 is positioned 2 -½ or 3 inches from the above the bottom support side. As shown, the mounting aperture 54 is configured to receive or house a base or end portion of pyrometric member or cone 56. In some embodiments, the pyrometric assembly 50 further includes a high temperature or refractory malleable clay or like material (not shown) that is positioned within the mounting aperture 54 and aids in coupling the base portion of the pyrometric member 56 in the mounting aperture 54. For example, the clay may be packed into the mounting aperture 54, and the base portion of the pyrometric member 56 may be forced into the mounting aperture 54 and into the clay to secure the base portion of the pyrometric member 56 in the mounting aperture 54.

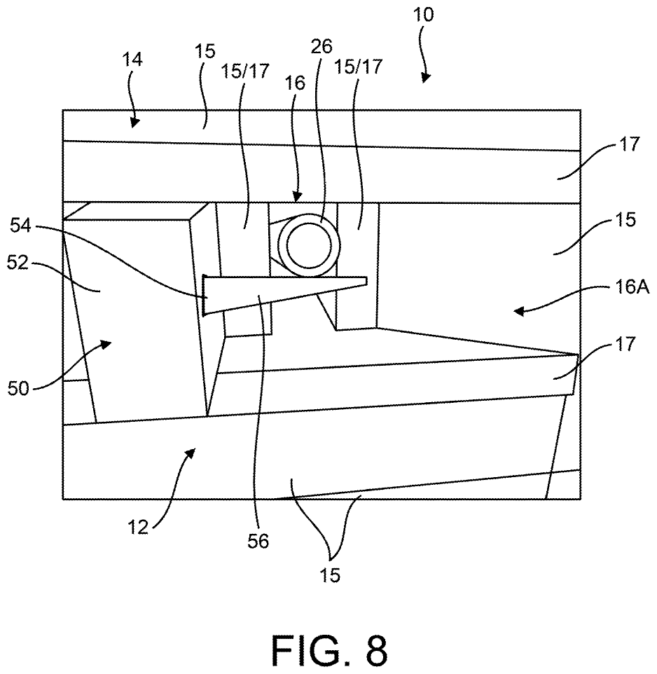

The pyrometric holder 52 and the pyrometric member 56 are configured such that when the base portion of the pyrometric member 56 (in a pre-heat worked state) is mounted in the mounting aperture 54, the pyrometric member 56 is in a cantilever orientation with respect to the mounting side of the pyrometric holder 52 in an elevated position above a bottom surface of the interior portion 16A of the switch opening 16. In its pre-heat worked state, the pyrometric member 56 is substantially rigid such and self-supporting such that it maintains the cantilever orientation and elevated position, as shown in FIGS. 2, 3, 8. In some embodiments, the pyrometric assembly 50 pyrometric holder 52 and the pyrometric member 56 are configured such that a top surface of the pyrometric member 56 extends substantially horizontally when the pyrometric member 56 is in the cantilever orientation, as shown in FIGS. 3 and 8. As shown in FIGS. 2 and 4, the pyrometric assembly 50 may be positioned on the end portion of the interior portion 16A of the switch opening 16 such that the pyrometric member 56 is substantially aligned with the interior sides or surface of the refractory wall 14.

As discussed further below, in the pre-heat worked state, the pyrometric member 56 is configured to maintain the cantilever orientation and elevated position, and physically support an inner portion of the inner sensing rod 26 to maintain a first orientation of the pivoting assembly 21, as shown in FIGS. 2, 3, 8. However, the pyrometric member 56 is also configured to soften after being subjected to a predetermined amount of heat work within the chamber 12 such that the pyrometric member 56 transitions from the pre-heat worked state to a post-heat worked state where the pyrometric member 56 deforms, bends or slumps downwardly into a deformed position extending toward the bottom side of the interior portion 16A of the switch opening 16, as shown in FIGS. 4, 5 and 9-12. That is, the pyrometric member 56 is configured to maintain its elevated position and support the pivoting assembly 21 in the first orientation thereof in its pre-heat worked state, and then deforms after being subjected to a predefined amount of heat work toward the bottom side of the interior portion 16A of the switch opening 16 to allow the pivoting assembly 21 to rotate into the second orientation, as shown in FIGS. 4, 5 and 9-12. After a use, the deformed pyrometric member 56, it its post-heat worked state, may be removed from the pyrometric holder 52, and the pyrometric holder 52 may be re-used with a new pyrometric member 56 (in its pre-heat worked state) with a subsequent firing of the kiln.

The pyrometric member 56 may be any pyrometric member configuration or type that deforms after a predetermined amount of heat work. In some embodiments, the pyrometric member 56 may be formed of a ceramic material. In some embodiments, the pyrometric member 56 comprise the shape of a pyramid, and defines a length of at least 2 or 2 -½ inches, such as at least 3 or 3-½ inches. In some embodiments may have a triangular cross-section, with flat sides extending to its tip. However, the pyrometric member 56 may be of any cross-sectional shape, and define any 3-dimensional elongate shape.

As shown in FIGS. 2-12 and briefly discussed above, the kiln 10 and the pyrometric member-based control switch device or system 20 may further include a pivoting or rotating switch system, assembly or device 21 configured to generate a control signal that causes the at least one heater 16 to reduce an amount of heat that it produces to stop the kiln chamber 12 from further heating (and the wares therein receiving further heat work) when the pyrometric member 56 deforms from the elevated position in its pre-heat worked state to its deformed position in its post-heat worked state. As noted above and shown in FIGS. 4, 5 and 9-12, it its post-heat worked state, the pyrometric member 56 is deformed into a deformed position with the pyrometric member 56 extending closer to the bottom surface of the interior portion 16A of the switch opening 16 than in the elevated position (its post-heat worked state). In some embodiments, the pyrometric member 56 may deform to, or past the bottom surface of the interior portion 16A of the switch opening 16, and/or the allow the inner sensing rod 26 in close proximity to (or in contact with) the bottom surface of the interior portion 16A.

In some embodiments, the pivoting switch assembly 21 includes a rotation member 22 that is rotatably coupled to the kiln 10 (e.g., via a mount, frame or the like), an inner sensing rod 26 extending from an inner side of the rotation member 22 and through the switch opening 16 to the interior portion 16A thereof, and an exterior contact rod 28 extending from an outer portion of the rotation member 26 comprising an electrically conductive first contact portion 30, as shown in FIGS. 2 and 4. The rotation member 22 is configured to rotate about an axis of rotation 24, which may be provided by at least one pin, bearing, sleeve, shaft or a combination thereof, for example.

The pivoting switch assembly 21 is configured to rotate about the axis of rotation 24 of the rotation member 22 between a first orientation with an inner end portion of the inner sensing rod 26 being spaced a first distance from the bottom side of the interior portion 16A of the switch opening 16 (via the pyrometric assembly 50) and the first contact portion 30 spaced from a second contact portion 32 (as shown in FIGS. 2, 3 and 6), and a second orientation with the inner end portion of the inner sensing rod 26 being positioned closer to the bottom side of interior portion 16A of the switch opening 16 than the first distance and the first contact portion 30 in physical and electrical connection with the second contact portion 32 (as shown in FIGS. 4, 5 and 9-11). The pivoting switch assembly 21 may comprise a center of gravity that is offset from the axis of rotation 24 toward the interior portion 16A of the switch opening 16 (toward the tip or end of the inner sensing rod 26 such that the pivoting assembly is naturally biased into the second orientation from the first orientation (i.e., naturally wants to rotate from the first orientation toward the second orientation). It is noted that the pivoting switch assembly 21 may also include a tare poise member 40 movably coupled along a length of the exterior contact rod 28 to alter the position of the center of gravity of the pivoting assembly 21, and thereby also alter the strength of the naturally-biased downward force of the inner sensing rod 26 at the interior portion 16A of the switch opening 16, as shown in FIGS. 2 and 4.

The rotation member 22 may be capable of withstanding temperatures of at least 2,000 degree Fahrenheit, and comprise high refractoriness, low thermal conductivity, and high thermal shock resistance. In some embodiments, the rotation member 22 may comprise an insulted block and/or comprise or be formed of a refractory material. In some embodiments, the rotation member 22 may be formed of a ceramic, such as alumina (Al₂O₃) and/or silica (SiO₂). In some embodiments, the rotation member 22 may have a thermal conductivity of less than 0.5 W/mK at mean temperature 2,000 degree Fahrenheit, and/or a coefficient of thermal expansion of less than about 6×10⁻⁶/° F. from about 1,500 degrees Fahrenheit to about 2,500 degrees Fahrenheit. In some embodiments, the rotation member 22 may be formed of the same or similar materials as insulating fire bricks (IFBs), refractory firebricks or the like.

As shown in FIGS. 2, 4 and 6, the rotation member 22 may be rotatably mounted to an exterior of the kiln 10 and positioned over or past an exterior side of the switch opening 16. The rotation member 22 may be substantially aligned with the exterior side of the switch opening 16 and sized and shaped such that it substantially blocks off and limits heat radiating to the exterior of the kiln 10 via the switch opening 16. To further reduce the amount of heat that may escape the exterior side of the switch opening 16, the pivoting switch assembly 21 may include one or more thermal insulation or gaskets between the inner side of the rotation member 22 and the exterior side of the switch opening 16, as also shown in FIGS. 2, 4 and 6. For example, the pivoting switch assembly 21 may include fiber insulation gaskets that extend over the exterior side of the switch opening 16 and about the inner sensing rod 26 and are positioned between the exterior of the kiln 10 and/or the exterior side of the switch opening 16 and the inner side of the rotation member 22. In some such embodiments, the inner ceramic sensing rod 26 may extend through an opening in the at least one fiber insulation gasket.

As discussed above and shown in FIGS. 2-12, the inner sensing rod 26 extends from an inner side of the rotation member 22 to the interior portion 16A of the switch opening 16. In some embodiments, the inner sensing rod 26 extends linearly along a longitudinal axis, and is symmetrically formed/shaped about the longitudinal axis. In some embodiments, the inner sensing rod 26 is a hollow (cylindrical) tube (e.g., a high fire or mullite ceramic tube), such as including a through hole extending from the tip thereof to the portion of the rotation member 22 coupled with/in the rotation member 22 (and thereby to the rotation member 22). The rotation member 22 may be of a fixed length, such as of at least 4-½ inches (to pass through the relatively thick high temperature kiln wall).

The inner sensing rod 26 is capable of withstanding temperatures of at least 2,000 degree Fahrenheit, and comprises high refractoriness, low thermal conductivity, and high thermal shock resistance (such that it does not distort or warp due to the heat of the kiln 10). In some embodiments, the inner sensing rod 26 may comprise or be formed of a refractory material. In some embodiments, the inner sensing rod 26 may be formed of a ceramic, such as alumina (Al₂O₃) and/or silica (SiO₂). In one such embodiment, the inner sensing rod 26 is formed of mullite. In some embodiments, the inner sensing rod 26 may have a thermal conductivity of less than 0.5 W/mK at mean temperature 2,000 degree Fahrenheit, and/or a coefficient of thermal expansion of less than about 6×10⁻⁶/° F. from about 1,500 degrees Fahrenheit to about 2,500 degrees Fahrenheit.

The inner sensing rod 26 and the rotation member 22 are preferably configured to be compatible in that they react to heat substantially similarly so that the connection therebetween remains intact, the orientation and position thereof is not altered or distorted, and the exterior contact rod 28 is substantially thermally insulated. For example, in some embodiments, the thermal conductivity of the rotation member 22 is within 10%, or within 5%, of the thermal conductivity of the inner sensing rod 26 at 2,000 degrees Fahrenheit. In some embodiments, the thermal conductivity of both the rotation member 22 and the inner sensing rod 66 is less than 0.5 W/mK, or less than 0.4 W/mK, at mean temperature 2,000 degrees Fahrenheit. In some embodiments, the coefficient of thermal expansion of the rotation member 22 is within 10%, or within 5%, of the coefficient of thermal expansion of the inner sensing rod 26 from about 1500 degrees Fahrenheit to about 2500 degrees Fahrenheit. In some embodiments, the coefficient of thermal expansion of both the rotation member 22 and the inner sensing rod 66 is less than 6×10⁻⁶/° F. from about 1500 degrees Fahrenheit to about 2500 degrees Fahrenheit.

As discussed above and shown in FIGS. 2 and 4, the exterior contact rod 28 extends from an outer portion of the rotation member 26 and comprises an electrically conductive first contact portion 30. In some embodiments, the exterior contact rod 28 may be substantially more thermally conductive than the inner sensing rod 26 and the rotation member 22. In some embodiments, the exterior contact rod may comprise or be formed of one or more electrically conductive metal rods extending from the rotation member 22 at least to the first contact portion 30. In some embodiments, the first electrical contact portion 30 is positioned at an exterior end of the contact rod 28.

As discussed above, in some embodiments, the exterior contact rod 28 may include a tare poise member 40 movably coupled along a length of the exterior contact rod 28, the position of the tare poise 28 along the exterior contact rod 28 configured to alter the center of gravity of the pivoting assembly 21, and thereby alter the strength of a naturally-biased downward force of the inner sensing rod 26 at the interior portion 16A of the switch opening 16. In some embodiments, the tare poise member 28 is threadably coupled with the exterior contact rod 28 such that the tare poise member 28 translated along the length of the exterior contact rod 28 and/or the exterior contact rod 28 lengthens/shortens (depending on the direction of rotation of the tare poise member 28). The tare poise member 28 can thereby be utilized to the balance or center of gravity of the pivoting assembly 21 to reduce the down force weight or force of the inner sensing rod 26. It is noted that too much down force of the inner sensing rod 26 may tear, break or bend the pyrometric member 56 during a fluxing/heat work process (before the post-heat worked state), and too little down force of the inner sensing rod 26 can cause a stall in its downward travel between the first and second orientations.

As shown in FIGS. 2 and 4, the second contact portion 32 of the pyrometric member-based control switch system 20 is positioned above the first contact portion 30 such that movement of the pivoting assembly 21 from the first orientation (FIG. 2) toward the second orientation (FIG. 4) brings the first and second contact portions 30, 32 toward each other until they physically and electrically couple/contact. In some embodiments, the position of the second contact portion 32 of the pyrometric member-based control switch system 20 may be adjustable. For example, in some embodiments, the second contact portion 32 comprises an adjustable height portion that is configured to vary the position of a contact surface of the second contact portion 32 relative to the first contact portion 30.

Via the first and second contact portions 30, 32, the pyrometric member-based control switch system 20 is able to generate a control signal when the pivoting assembly 21 is in the second orientation with the first and second contact portions 30, 32 being in electrical contact. For example, as shown in FIGS. 2 and 4, an electrical signal 34 (e.g., a low current or voltage signal, such as 12V) may be applied to the first contact portion 30, and the electrical signal transmitted to the second contact portion 32 when the pivoting assembly 21 is in the second orientation to produce or pass a control signal 35. In some embodiments, a 12V relay is coupled 34, 35 to the first and second contact portions 30, 32. Electrical contact/coupling of the first and second contact portions 30, 32 may pass a signal 34 that is applied to the first contact portion 30 to the second contact portion 32, which passes the signal as a control signal 35 to a controller, electrical device or the like that ultimately controls the heating of the at least one heating device 16, as discussed above. In some embodiments, the second contact portion 32 passes a signal to a relay coil 35, which powers a shut off relay that shuts off or otherwise stops the at least one heating deice 16 from further heating the kiln chamber 12.

Accordingly, in use, the elongate pyrometric member 52 is mounted in the mounting aperture 54 of the pyrometric holder 52, in a pre-heat worked state thereof, such that the pyrometric member 52 is in a cantilever orientation with respect to the mounting side of the pyrometric holder 52 in an elevated position above a bottom side of the pyrometric holder 52, as shown in FIGS. 2, 3 and 8. The pyrometric assembly 50 is then positioned (e.g., manually) on the interior portion 16A of the switch opening 16 such that the bottom side of the pyrometric holder 52 is seated on bottom surface of the switch opening 16, and the cantilevered pyrometric member 52 is an elevated position above the bottom surface of the switch opening 16 and spaced therefrom a first distance (e.g., with respect to a top surface or edge of the pyrometric assembly 50). In some embodiments, the first distance may be at least about ¾ inch, such as about 1 inch. The inner end portion of the inner sensing rod 26 may be positioned on the cantilevered pyrometric member 52, and the pyrometric member 56 maintains/supports the inner end portion of the inner sensing rod 26 in the elevated position above the bottom surface of the switch opening 16 the first distance, thereby maintaining the pivoting assembly 21 in the first orientation (with the first contact portion 30 spaced from the second contact portion 32), as shown in FIGS. 2, 3 and 8.

In the pre-heat worked state, the pyrometric member 56 is configured to maintain the elevated position, and physically support the inner portion of the inner sensing rod 26 in the elevated position to maintain the first orientation of the pivoting assembly 21. However, the pyrometric member 56 is also configured to soften after being subjected to a predetermined amount of heat work to transition the pyrometric member 56 from the pre-heat worked state to the post-heat worked state with the pyrometric member 56 in the deformed position and the pivoting assembly 21 allowed to naturally pivot or rotate (due to the natural bias thereof) into the second orientation, as shown in FIGS. 4, 5, 11 and 12. As shown, once the predetermined amount of heat work is produced within the chamber 12, the pyrometric member 56 is in the post-heat worked state such that the pyrometric member 56 deforms into a shape or configuration where it extends toward (and potentially to) the bottom surface of interior portion 16A of the switch opening 16, thereby allowing the inner end portion of the inner sensing rod 26 to travel at least partially toward (and potentially to) the bottom surface of interior portion 16A such that the pivoting assembly 21 pivots into the second orientation with the first and second contact portions 30, 32 in electrical contact (to send or generate the cutoff control signal to the at least one heating device 16).

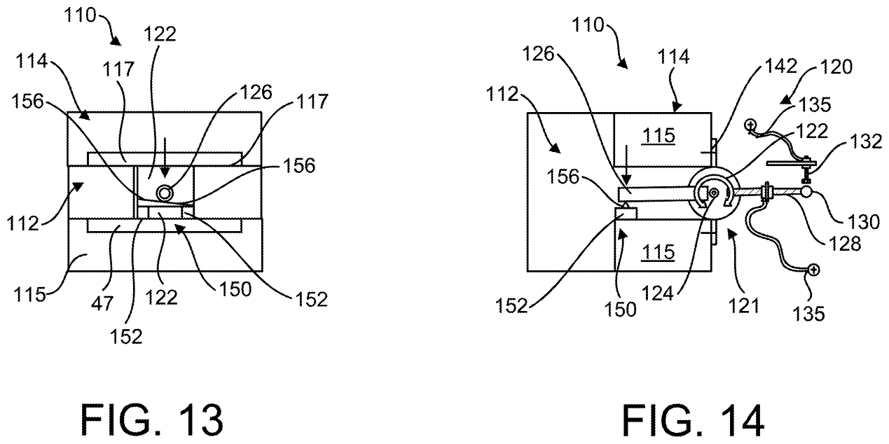

FIGS. 13 and 14 illustrate another exemplary kiln 110 and the pyrometric member-based control switch device or system 120. The kiln 110 and the pyrometric member-based control switch device or system 120 shown in FIGS. 13 and 14 are substantially similar to the kiln 10 and the pyrometric member-based control switch device or system 20 described above with respect to FIGS. 1-12, and therefore like reference numerals preceded with “1” are used to indicate like components, aspects, functions, portions, members, functions and the like, and the description above directed to thereto equally applies, and may not be repeated hereinbelow for brevity and/or clarity purposes.

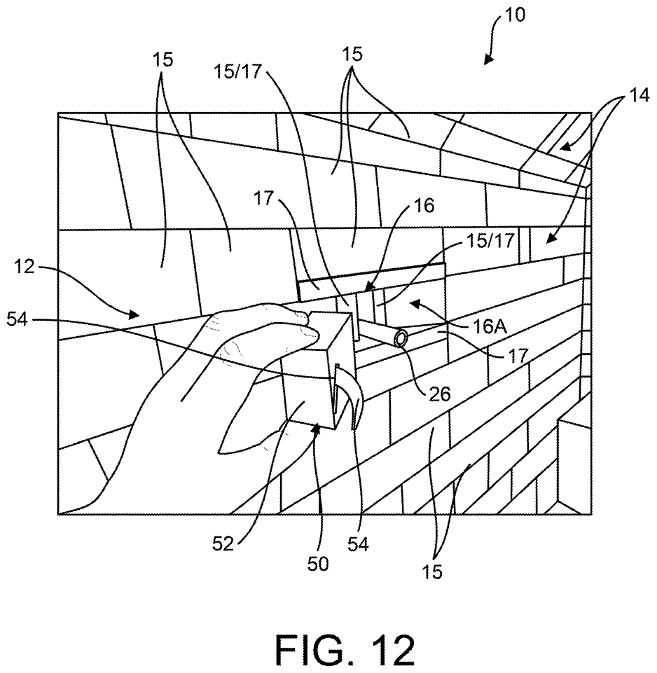

As shown in FIGS. 12 and 14, the kiln 110 and the pyrometric member-based control switch device or system 120 differ from the kiln 10 and the pyrometric member-based control switch device or system 20 in that the rotation member 122 is rounded (e.g., a circular cross-section), rather than brick or rectilinear-shaped, and extends at least partially into the exterior portion of the switch opening 116.

The kiln 110 and the pyrometric member-based control switch device or system 120 also differ from the kiln 10 and the pyrometric member-based control switch device or system 20 in the configuration of the pyrometric assembly 150. As shown in FIGS. 13 and 14, the pyrometric holder 152 support both ends of the pyrometric member 156 such that is it not cantilevered, but rather spans across a gap. The medial portion of the pyrometric member 156 thereby supports the inner end portion of the inner sensing rod 126 in the elevated position, and “slumps” after the pre-determined amount of heat work to allow the inner sensing rod 126 to drop and the pivoting assembly 121 to rotate into the second orientation (not shown).

It is to be understood that the above description is intended to be illustrative, and not restrictive. For example, the above-described examples (and/or aspects thereof) may be used in combination with each other. In addition, many modifications may be made to adapt a particular situation or material to the teachings of the various examples without departing from their scope. While dimensions and types of materials may be described herein, they are intended to define parameters of some of the various examples, and they are by no means limiting to all examples and are merely exemplary. Many other examples will be apparent to those of skill in the art upon reviewing the above description. The scope of the various examples should, therefore, be determined with reference to the appended claims, along with the full scope of equivalents to which such claims are entitled.

In the appended claims, the terms “including” and “in which” are used as the plain-English equivalents of the respective terms “comprising” and “wherein.” Moreover, in the following claims, the terms “first,” “second,” and “third,” etc. are used merely as referee labels, and are not intended to impose numerical, structural or other requirements on their objects. Forms of term “based on” herein encompass relationships where an element is partially based on as well as relationships where an element is entirely based on. Forms of the term “defined” encompass relationships where an element is partially defined as well as relationships where an element is entirely defined. Further, the limitations of the following claims are not written in means-plus-function format and are not intended to be interpreted based on 35 U.S.C. § 112, sixth paragraph, unless and until such claim limitations expressly use the phrase “means for” followed by a statement of function cavity of further structure. It is to be understood that not necessarily all such objects or advantages described above may be achieved in accordance with any particular example. Thus, for example, those skilled in the art will recognize that the devices, systems and methods described herein may be embodied or carried out in a manner that achieves or optimizes one advantage or group of advantages as taught herein without necessarily achieving other objects or advantages as may be taught or suggested herein.

While the disclosure has been described in detail in connection with only a limited number of examples, it should be readily understood that the disclosure is not limited to such disclosed examples. Rather, this disclosure can be modified to incorporate any number of variations, alterations, substitutions or equivalent arrangements not heretofore described, but which are commensurate with the spirit and scope of the disclosure. Additionally, while various examples have been described, it is to be understood that aspects of the disclosure may include only one example or some of the described examples. Also, while some disclosure are described as having a certain number of elements, it will be understood that the examples can be practiced with less than or greater than the certain number of elements.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

1. A kiln, comprising:
a chamber defined by interior refractory walls;
at least one heater configured to heat the chamber to at least 2,000 degrees Fahrenheit;
a pyrometric assembly positioned on an interior portion of a switch opening extending through one of the interior walls, comprising:
a pyrometric holder with a bottom support side seated on a bottom side of the interior portion of the switch opening and a mounting side with a mounting aperture extending therein; and
an elongate pyrometric member configured to be mounted in the mounting aperture such that in a pre-heat worked state, the pyrometric member is in a cantilever orientation with respect to the mounting side of the pyrometric holder in an elevated position above a bottom surface of the switch opening;
a switching device configured to generate a control signal that causes the at least one heater to reduce an amount of heat that it produces, comprising:
a pivoting assembly, comprising:
a rotation member comprising a refractory material rotatably mounted to the kiln about an axis of rotation;
an sensing rod comprising a refractory material extending from an inner side of the rotation member and through the switch opening to the interior portion; and
an exterior contact rod extending from an outer portion of the rotation member comprising an electrically conductive first contact portion; and
an electrically conductive second contact portion positioned above the first contact portion,
wherein the pivoting assembly is configured to rotate about the axis of rotation between a first orientation with an inner end portion of the sensing rod being spaced a first distance from the bottom side of the switch opening and the first contact portion is spaced from the second contact portion, and a second orientation with the inner end portion of the sensing rod being positioned closer to the bottom side of the switch opening than the first distance and the first contact portion is in physical and electrical connection with the second contact portion, and
wherein a center of gravity of the pivoting assembly is offset from the axis of rotation toward the interior portion of the switch opening such that the pivoting assembly is naturally biased into the second orientation.

2. The kiln according to any claim 1, wherein, in a first configuration of the kiln:
the pyrometric member is in the pre-heat worked state and mounted in the mounting aperture such that the pyrometric member is in the cantilever orientation and the elevated position;
the inner portion of the sensing rod is positioned on the pyrometric member; and
the pyrometric member maintains its elevated position and supports the pivoting assembly in the first orientation.

3. The kiln according to any claim 2, wherein, in a second configuration of the kiln:
the pyrometric member is mounted in the mounting aperture and in a post-heat worked state such that the pyrometric member is in a deformed position that extends closer to the bottom surface of the switch opening than in the elevated position; and
the pivoting assembly is in the second orientation.

4. The kiln according to claim 3, wherein, in the pre-heat worked state, the pyrometric member is configured to maintain the elevated position, and physically support the inner portion of the sensing rod to maintain the first orientation of the pivoting assembly, and wherein the pyrometric member is configured to soften after being subjected to a predetermined amount of heat work to transition the pyrometric member from the pre-heat worked state to the post-heat worked state with the pyrometric member in the deformed position and the pivoting assembly biased into the second orientation.

5. The kiln according to claim 1, wherein, in the second orientation, the inner end portion of the sensing rod lies on the bottom side of the switch opening.

6. The kiln according to claim 1, wherein an electrical signal is applied to the second contact portion, wherein the electrical signal is transmitted to the second contact portion when the switching device is in the second orientation to produce the control signal, and wherein the control signal causes the at least one heater to stop heating the kiln chamber.

7. The kiln according to claim 1, wherein the exterior contact rod comprises an electrically conductive metal rod portion extending from the rotation member to the first contact portion, wherein the electrical contact portion is positioned at an end of the exterior contact rod, and wherein an electrical signal is applied to the second contact portion via the exterior contact rod.

8. The kiln according to claim 1, wherein the pivoting assembly further comprises a tare poise member threadably movably coupled along a length of the exterior contact rod, the position of the tare poise along the exterior contact rod configured to alter the center of gravity of the pivoting assembly, and thereby alter the strength of a naturally-biased downward force of the sensing rod at the interior portion of the switch opening, and wherein the second contact portion comprises an adjustable height portion that is configured to vary the position of a contact surface of the second contact portion relative to the first contact portion.

9. The kiln according to claim 1, wherein the sensing rod is a ceramic hollow mullite tube.

10. The kiln according to claim 1, wherein the switch opening extends for a length of at least 4-½ inches, and the inner ceramic sensing rod defines a length of at least 4-½ inches, wherein a top side of the mounting aperture of the pyrometric holder is positioned at least 1 inch above the bottom support side, and wherein the first distance of the inner end portion of the sensing rod from the bottom side of the switch opening is at least ¾ inch.

11. The kiln according to claim 1, wherein the elongate pyrometric member defines a length from a base portion to a tip portion of at least 2 inches, and wherein the pyrometric assembly is configured such that a top surface of the pyrometric member extends substantially horizontally when the pyrometric member is in the cantilever orientation.

12. The kiln according to claim 11, wherein the elongate pyrometric member is a pyramidal pyrometric cone.

13. The kiln according to claim 1, wherein the pyrometric holder is formed of a refractory material, and wherein the pyrometric holder is removably seated on the bottom side of the interior portion of the switch opening.

14. The kiln according to claim 1, wherein the pyrometric assembly further comprises a malleable refractory clay positioned within the mounting aperture coupling a base portion of the pyrometric member in the mounting aperture.

15. The kiln according to claim 1, wherein the switch opening is formed between refractory brick sides and top and bottom ceramic lintel supports, and wherein the top and bottom ceramic lintel supports are denser, smoother and less abradable by the pyrometric holder than the refractory brick sides.

16. The kiln according to claim 1, wherein the thermal conductivity of the rotation member is within 10% of the thermal conductivity of the sensing rod at 2,000 degree Fahrenheit, wherein the kiln further comprises at least one fiber insulation gasket extending over an exterior end of the switch opening, and wherein the sensing rod extends through an opening in the at least one fiber insulation gasket.

17. The kiln according to claim 16, wherein the thermal conductivity of the rotation member and the thermal conductivity of the sensing rod is less than 0.5 W/mK at mean temperature 2,000 degree Fahrenheit, or wherein the coefficient of thermal expansion of the rotation member and the coefficient of thermal expansion of the sensing rod is less than 6×10⁻⁶/° F. from about 1500 degrees Fahrenheit to about 2500 degrees Fahrenheit.

18. The kiln according to claim 1, wherein the interior portion of the switch opening defines a larger width than a medial portion of the switch opening, and wherein the bottom side of the interior portion of the switch opening is defined by a ceramic lintel.

19. The kiln according to claim 1, wherein the rotation member is rotatably mounted to an exterior of the kiln and positioned over an exterior side of the switch opening.

20. The kiln according to claim 1, wherein the switching device is configured to generate a control signal when the pivoting assembly is in the second orientation with the first and second contact portions being in electrical contact, wherein the at least one heater comprises at least one gas burner, and wherein the control signal ultimately operates a valve which supplies a combustible gas to the at least one gas burner.

21. A method, comprising:
utilizing the kiln according to claim 1 to fire a ware, comprising:
positioning the ware within the kiln chamber;
mounting a the pyrometric member in the mounting aperture of the pyrometric holder in the pre-heat worked state such that the pyrometric member is in the cantilever orientation with respect to the mounting side of the holder;
positioning the pyrometric member in the interior portion of the mounting aperture such that the pyrometric member is the elevated position above the bottom surface of the switch opening and the pivoting assembly is in the first orientation with the sensing rod being supported by the pyrometric member;
heating the kiln chamber to at least 2,000 degrees Fahrenheit via the at least one heater for a period of time such that the pyrometric member experiences an amount of heat work that causes the pyrometric member to deform into the deformed position and the pivoting assembly rotates into the second orientation,
wherein the rotation of the pivoting assembly into the second orientation places the first contact portion in physical and electrical connection with the second contact portion, and generates the control signal that causes the at least one heater to cutoff the heating of the kiln chamber.
